(19) United States
(12) Patent Application Publication
(10) Pub. No.: US 2014/0187365 A1
(43) Pub. Date: Jul. 3, 2014

(54) V-BELT TYPE CONTINUOUSLY VARIABLE TRANSMISSION

(71) Applicant: KAWASAKI JUKOGYO KABUSHIKI KAISHA, Hyogo (JP)

(72) Inventors: Yuji KOUMA, Takasago-shi (JP); Taisuke MORITA, Amagasaki-shi (JP); Seiji ITOO, Akashi-shi (JP)

(73) Assignee: KAWASAKI JUKOGYO KABUSHIKI KAISHA, Hyogo (JP)

(21) Appl. No.: 13/729,719

(22) Filed: Dec. 28, 2012

(51) Int. Cl. F16H 9/16

(52) U.S. Cl. CPC F16H 9/16
USPC 474/8

(57) ABSTRACT

A V-belt type continuously variable transmission includes a drive shaft, a drive pulley assembly, a driven shaft, a driven pulley assembly, a V belt, and a transmission case assembly, the drive shaft is formed as a separate body from the crankshaft, one axial end of the drive shaft is spline-fitted to a shaft coupling portion provided in an end of the crankshaft, freely move in the axial direction within a predetermined distance, and be permitted to fall slightly, and the other axial end of the drive shaft is supported in the transmission case assembly or via a front bearing.

### BACKGROUND OF THE INVENTION

1. Field of the Invention

The present invention relates to a V-belt type continuously variable transmission for utility vehicle to be coupled to a crankshaft of an engine so as to transmit motive power.

2. Description of the Related Art

U.S. Pat. No. 6,398,683 B1 discloses a conventional structure of the V-belt type continuously variable transmission, and the structure is shown in FIG. 10. In FIG. 10, a drive shaft 202 is coupled to an end of a crankshaft 201 of an engine via a centrifugal clutch (not entirely shown), and a drive pulley assembly 210 including a fixed sheave 210a and a movable sheave 210b is installed on an outer circumferential surface of the drive shaft 202. The drive pulley assembly 210 and a driven pulley assembly (not shown) on the rear side are coupled by a V belt 213 so as to transmit motive power.

A crankcase cover (a transmission case main body and a cover) 206 is attached to an end surface in the crankshaft direction of a crankcase 205, and the drive pulley assembly 210 and the driven pulley assembly are accommodated in the crankcase cover 206.

One end of the drive shaft 202 is combined with an output member 209 of the centrifugal clutch by welding, and the output member 209 is rotatably supported on a journal bearing portion in the crankcase 205 via a bearing 203. The other end of the drive pulley shaft 202 is rotatably supported on a metal bearing boss portion 207 serving as a separate body from the transmission cover 206 via a bearing 208. The bearing boss portion 207 is integrally provided with a plurality of support legs 207a, and the support legs 207a are fixed to the end surface of the crankcase 205 together with the crankcase cover 206.

As another conventional example, Unexamined Japanese Patent Publication No. 2003-184972 discloses a V-belt type continuously variable transmission having a belt clutch function. The belt clutch function is a configuration capable of cutting off friction motive power transmission between a V belt and a drive pulley assembly. One end of a drive shaft is rigidly combined with a crankshaft, and the other end of the drive shaft is in a free state. That is, the drive shaft is cantilevered.

In the former case of FIG. 10, the drive shaft 202 is supported on both sides. Thus, although rigidity against a bending action is increased, there is a need for providing a housing portion for supporting the bearing 203 in the crankcase.

In the latter case, the drive shaft is cantilevered. Thus, during driving, when tensile force of the V belt acts on the drive pulley assembly, the drive shaft and the crankshaft integrated with this are bent, so as to cause a vibration. There is also a need for increasing strength (such as thickness) of the crankshaft.

In a structure that a crankshaft and a drive shaft of a V-belt type continuously variable transmission are integrated or rigidly combined, and the drive shaft is supported on both sides, the following problems will be occurred. In a case where an error between an axis of a bearing for the drive shaft provided in a transmission case and an axis of a journal bearing for the crankshaft in a crankcase is increased due to accumulation of a manufacturing error, the drive shaft cannot be highly precisely attached at the time of attaching, so as to cause a vibration or a noise during engine operation, or a weight increase for improving strength of the crankshaft.

### SUMMARY OF THE INVENTION

The present invention is achieved in consideration with the above problem, and an object thereof is, in a V-belt type continuously variable transmission to be coupled to a crankshaft of an engine, to suppress bending of the crankshaft and bending of the drive shaft during engine operation, even in a case where an error between an axis of a bearing boss portion and an axis of a journal bearing portion in the engine is increased due to accumulation of a manufacturing error.

In order to achieve the above object, the V-belt type continuously variable transmission according to the present invention is a V-belt type continuously, variable transmission to be coupled to a crankshaft of an engine so as to transmit motive power, including a drive shaft, a drive pulley assembly provided in the drive shaft, a driven shaft, a driven pulley assembly provided in the driven shaft, a V belt looped over both the pulley assemblies, and a transmission case assembly for accommodating the drive shaft, the driven shaft, both the pulley assemblies, and the V belt, wherein the drive shaft is formed as a separate body from the crankshaft, one axial end of the drive shaft is spline-fitted to a shaft coupling portion provided in an end of the crankshaft so as to transmit rotation force, freely move in the axial direction within a predetermined distance, and be permitted to fall slightly, and an other axial end of the drive shaft is supported in the transmission case assembly or on a bearing boss portion provided in a part of the transmission case assembly via a bearing so as to move in the axial direction within the predetermined distance.

According to the above configuration, the transmission drive shaft is formed as a separate body from the crankshaft, supported on both sides, and further spline-fitted to the crankshaft so as to be permitted to fall slightly and move in the axial direction. Thus, even in a case where the error between the axis of the bearing boss portion and the axis of the journal bearing portion in the engine is increased due to the accumulation of the manufacturing error, in comparison to a structure that a drive shaft is rigidly combined with a crankshaft, warp (bending) of the crankshaft and warp (bending) of the drive shaft during the engine operation can be suppressed. The drive shaft can be easily assembled, so that a vibration of the drive shaft during the operation can be suppressed.

The present invention can be provided with the following characteristics in addition to the above configuration.

(a) The transmission case assembly includes a transmission case main body attached to a crankcase of the engine, and a resin transmission cover attached to the transmission case main body, and the bearing boss portion is formed of a metal material as a separate body from the transmission case assembly.

According to the above configuration (a), with the resin transmission cover, weight of the entire transmission can be reduced. Meanwhile, by forming the metal bearing boss portion as a separate body from the transmission cover, support rigidity of the drive shaft can be maintained high.

(b) In the structure that the bearing boss portion is formed as a separate body from the transmission cover as in the above configuration (a), further preferably, the transmission cover has a through hole in which the bearing boss portion is fitted and supported, and an axial end surface of the bearing boss portion is exposed to an exterior of the transmission cover.

According to the above configuration (b), by fitting the bearing boss portion in the through hole at the time of attaching the transmission cover, the transmission cover can be readily positioned and supported.

(c) In the structure that the transmission cover has the through hole as in the above configuration (b), further preferably, the bearing boss portion has an oil charging hole providing communication between the end surface exposed to the exterior of the transmission cover and a point where the bearing is arranged.

According to the above configuration (c), since the oil hole opening in the exposed end surface of the bearing boss portion is formed, oil such as grease can be charged into the bearing from the exterior without detaching the transmission cover.

(d) In the structure that the bearing portion is fitted in the through hole of the transmission cover as in the above configuration (b), further preferably, the bearing boss portion integrally has a plurality of support legs curved along an inner circumferential surface of the transmission cover, and the support legs are secured to the transmission case main body.

According to the above configuration (d), since the support legs are secured to the transmission case main body, support rigidity of the support legs can be maintained high, and the axis of the journal bearing portion of the engine and the axis of the bearing boss portion are easily matched with each other.

(e) In the V-belt type continuously variable transmission with the above configuration, the drive pulley assembly has a belt clutch function capable of canceling a nipping pressure on the V belt by a pair of sheaves.

According to the above configuration (e), in the V-belt type continuously variable transmission having the belt clutch function, every time when the belt clutch is changed between an engage state (ON) and a disengage state (OFF), tensile force is shockingly applied to the drive pulley assembly. However, even in a case where such shock is repeatedly generated, with the drive shaft being supported on both sides, the warp of the drive shaft can be prevented.

(f) As another example, a metal transmission cover of for example aluminum or an aluminum alloy material is provided in place of the resin transmission cover.

According to the above configuration (f), rigidity of the transmission cover can be enhanced. Particularly, in a case of aluminum or an aluminum alloy, the weight can be reduced.

### BRIEF DESCRIPTION OF THE DRAWINGS

FIG. 1 is a schematic plan view of an engine for a utility vehicle provided with a V-belt type continuously variable transmission according to the present invention;

FIG. 2 is a left side view of the V-belt type continuously variable transmission of FIG. 1;

FIG. 3 is a front view of the V-belt type continuously variable transmission of FIG. 1;

FIG. 4 is a front view of the V-belt type continuously variable transmission of FIG. 1 in a state that a transmission case main body and a transmission cover are detached;

FIG. 5 is a perspective view in which the V-belt type continuously variable transmission of FIG. 1 is seen from the left upper side;

FIG. 6 is an enlarged sectional view by line VI-VI of FIG. 2;

FIG. 7 is a perspective view in which the V-belt type continuously variable transmission of FIG. 1 in a state that the transmission cover is detached is seen from the left upper side;

FIG. 8 is a perspective view in which the V-belt type continuously variable transmission of FIG. 1 in a state that the transmission cover is detached is seen from the left lower side;

FIG. 9 is a perspective view in which the V-belt type continuously variable transmission of FIG. 1 in a state that the transmission cover and a drive pulley assembly are detached is seen from the left rear side; and

FIG. 10 is a sectional view of a conventional example.

### DETAILED DESCRIPTION OF THE INVENTION

### Embodiment of the Invention

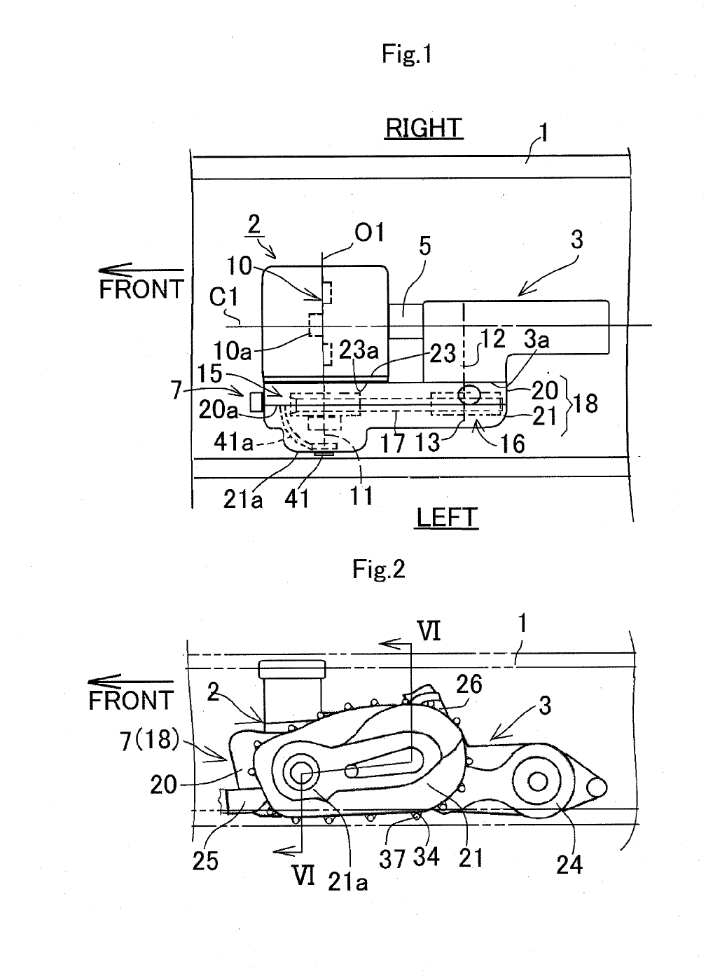

FIGS. 1 to 9 show an engine for utility vehicle provided with a V-belt type continuously variable transmission according to the present invention, and one embodiment of the present invention will be described based on these figures. It should be noted that for convenience of illustration, the front and rear direction of a vehicle is called as the front and rear direction of the engine and other parts, and the left and right sides seen from a passenger in the vehicle (left and right sides seen from the rear side of the vehicle) in the vehicle width direction are called as the left and right sides of the vehicle, the engine, and other parts in the following description.

FIG. 1 is a plan view of the engine for the utility vehicle provided with the V-belt type continuously variable transmission. A vehicle body frame 1 of the utility vehicle is formed into a cubic shape elongated in the front and rear direction, and an engine 2 and a gear type transmission 3 are arranged in the vehicle body frame 1. The gear type transmission 3 is formed as a separate body from the engine 2 and arranged behind the engine 2. A rear surface of the engine 2 and a front surface of the gear type transmission 3 are rigidly coupled by a coupling bracket 5.

The engine 2 is a parallel 3-cylinder engine in which three cylinders are arranged in line in the vehicle width direction (lateral direction). A crankshaft 10 is substantially horizontally arranged in parallel with the vehicle width direction. The entire engine 2 is arranged in such a manner that a center crank portion 10a of the crankshaft 10 is substantially positioned on a center line C1 of the vehicle width direction of the vehicle body frame 1. The coupling bracket 5 and the gear type transmission 3 are also arranged so as to be positioned on the center line C1 of the vehicle body frame 1.

A V-belt type continuously variable transmission 7 is arranged so as to range from a left end surface of the engine 2 to a left end surface of a front part of the gear type transmission 3. The V-belt type continuously variable transmission 7 includes a transmission drive shaft 11 coupled to a left end of the crankshaft 10, a transmission driven shaft 13 coupled to a left end of an input shaft 12 of the gear type transmission 3, a drive pulley assembly 15 installed on an outer circumferential surface of the drive shaft 11, a driven pulley assembly 16 installed on an outer circumferential surface of the driven shaft 13, a V belt 17 looped over both the pulley assemblies 15, 16, and a transmission case assembly 18 covering the drive pulley assembly 15 and the driven pulley assembly 16. The V-belt type continuously variable transmission 7 continuously varies rotation of the crankshaft 10 and transmits the varied rotation to the input shaft 12 of the gear type transmission 3.

The transmission case assembly 18 includes an aluminum or aluminum-alloy transmission case main body 20, and a resin transmission cover 21. A front part of the transmission case main body 20 is attached to a case attachment surface 23a of a coupling plate 23 combined with a left end surface of a crankcase 2a of the engine 2, and a rear part of the transmission case main body 20 is attached to a case attachment surface 3a formed in a left end of the front part of the gear type transmission 3. The transmission cover 21 is attached to a cover attachment surface 20a formed in a left end of the transmission case main body 20. It should be noted that metal other than aluminum or an aluminum alloy can also be used for the transmission case main body 20.

FIG. 2 is a side view of FIG. 1. A lower end of the engine 2, a lower end of the gear type transmission 3, and a lower end of the V-belt type continuously variable transmission 7 are set at the substantially same height, and a final reducer 24 for rear wheels is provided in a rear end of the gear type transmission 3. A cooling air intake port 25 is formed in a front end of the transmission case main body 20, and a cooling air discharge port 26 is formed in an upper part of a rear part of the transmission case main body 20.

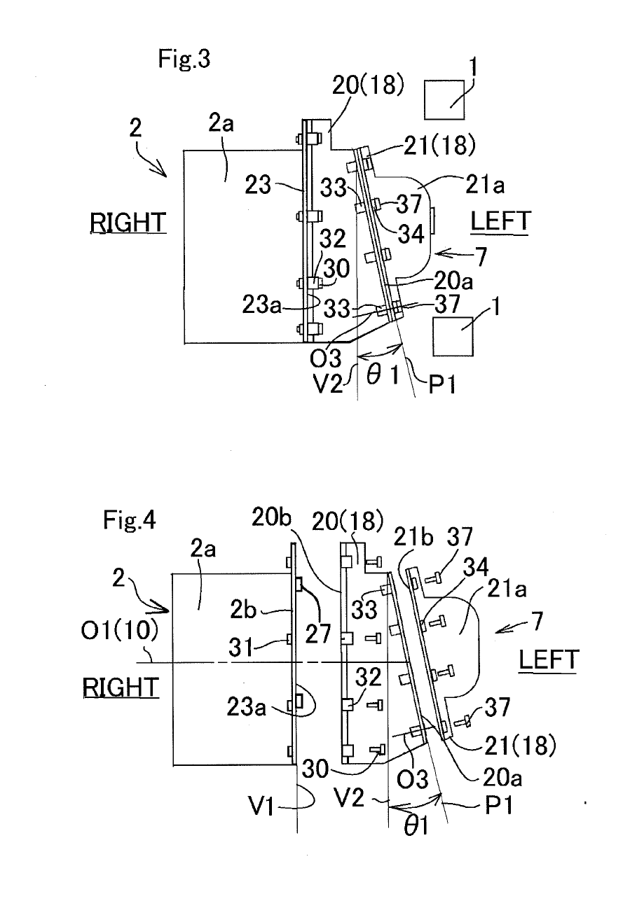

FIG. 3 is a front view of the engine 2 and the V-belt type continuously variable transmission 7, and FIG. 4 is an exploded front view of a state that the transmission case main body 20 and the transmission cover 21 are detached from the crankcase 2a. In FIGS. 3 and 4, a plate attachment surface 2b is formed in a vertical plane which is orthogonal to an axis line C1 of the crankshaft 10 in a left end of the crankcase 2a, and the coupling plate 23 is attached to the plate attachment surface 2b by a plurality of bolts 27. The coupling plate 23 has the case attachment surface 23a in a vertical plane V1 which is orthogonal to the axis line C1 of the crankshaft 10, and the transmission case main body 20 is attached to the case attachment surface 23a by a plurality of bolts 30.

Details will be described. A plurality of nuts 31 is secured to a right side surface of the coupling plate 23 (surface on the side of the crankcase 2a) by welding, while a plurality of boss portions 32 for bolt insertion is formed at positions corresponding to the nuts 31 in a circumference of a case attached surface 20b of the transmission case main body 20. By inserting the bolts 30 into bolt insertion holes of the boss portions 32 and screwing the bolts into the nuts 31, the transmission case main body 20 is attached to the case attachment surface 23a of the coupling plate 23.

The cover attachment surface 20a is formed in the left end of the transmission case main body 20. The cover attachment surface 20a is formed in one plane P1 inclined by a fixed inclination angle θ1 so as to extend downward and outward in the vehicle width direction (leftward) with respect to a vertical plane V2 which is orthogonal to the axis line O1 of the crankshaft 10. A plurality of female screw portions 33 is formed at intervals in an outer circumference of the cover attachment surface 20a. A female screw hole center line O3 of each of the female screw portions 33 is orthogonal to the cover attachment surface 20a (inclination plane P1).

A plurality of boss portions 34 having bolt insertion holes is formed at positions corresponding to the female screw portions 33 of the transmission case main body 20 in an outer circumference of a cover attached surface 21b of the transmission cover 21. The cover attached surface 21b of the transmission cover 21 is suited to the inclined-shape cover attachment surface 20a of the transmission case main body 20. By screwing the plurality of bolts 37 inserted into the boss portions 34 of the transmission cover 21 into the female screw portions 33 of the transmission case main body 20, the transmission cover 21 is attached to the cover attachment surface 20a of the transmission case main body 20.

In sum, the transmission case main body 20 is attached to the case attachment surface 23a of the vertical coupling plate 23 by the plurality of bolts 30 in substantially parallel with the axis line O1 of the crankshaft 10. Meanwhile, the transmission cover 21 is attached to the cover attachment surface 20a of the transmission case main body 20 by the plurality of bolts 37 inclined in such a manner that outer ends in the vehicle width direction are positioned on the upper side with respect to the axis line O1 of the crankshaft 10. An inclination angle θ1 of the cover attachment surface 20a is set to be about 10° to 30° for example.

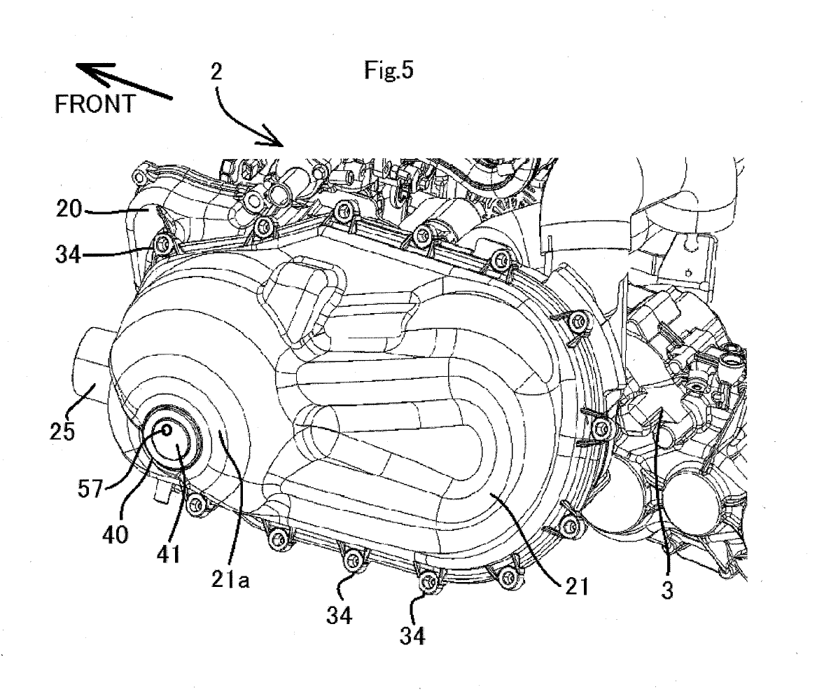

FIG. 5 is a perspective view seen from the rear upper side of the V-belt type continuously variable transmission (however, cover attachment bolts are omitted). A front portion 21a of the transmission cover 21 is formed into a dome shape or a partially spherical shape, and protrudes outward in the vehicle width direction (leftward). A circular through hole 40 is formed in a top part of the dome shape front portion 21a. An end portion of a bearing boss portion 41 arranged inside the transmission cover 21 is fitted into the through hole 40, and an end surface of the bearing boss portion 41 is exposed to an exterior from the transmission cover 21.

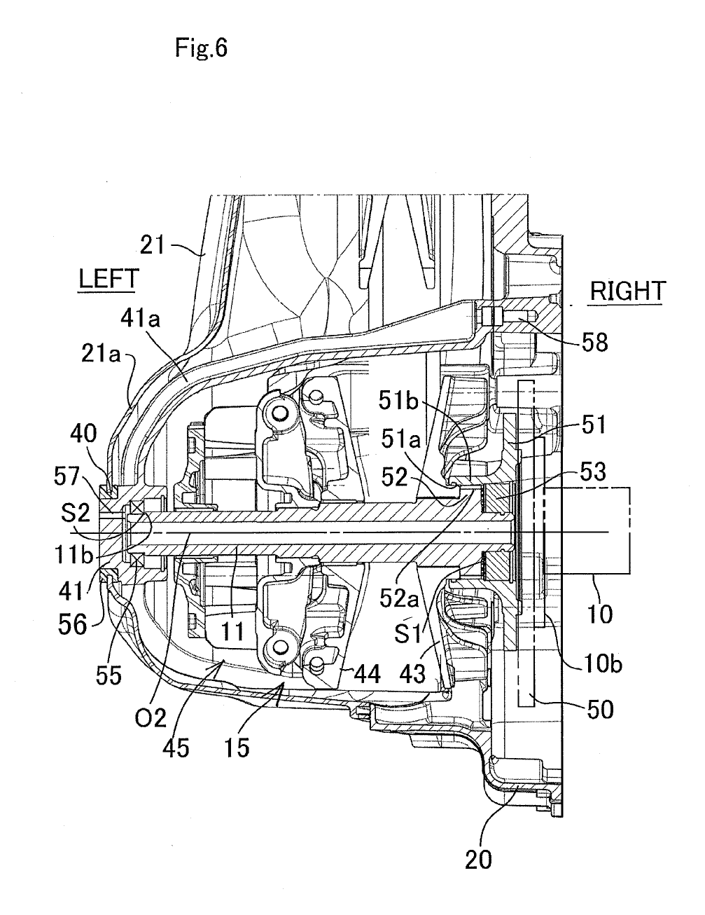

FIG. 6 is an enlarged sectional view by line VI-VI of FIG. 2 showing details of the drive shaft 11 and the drive pulley assembly 15 of the V-belt type continuously variable transmission 7. In FIG. 6, the drive pulley assembly 15 includes a fixed sheave 43 screwed in the vicinity of a right end of the drive shaft 11 so as not to move in the drive shaft direction, a movable sheave 44 fitted to the drive shaft 11 so as to move in the drive shaft direction, and a flyweight type sheave thrust generation mechanism 45.

The crankshaft 10 has a flange portion 10b in the left end. A flywheel 50 is fastened to the flange portion 10b by a plurality of bolts, and a coupling 51 is fastened to the flywheel 50 by a plurality of bolts. The coupling 51 is integrally provided with a tube portion 51b having inner spline teeth 51a, while an extended diameter portion 52 having outer spline teeth 52a is formed in the right end of the drive shaft 11. By spline-fitting the outer spline teeth 52a of the drive shaft 11 to the inner spline teeth 51a of the coupling 51, the drive shaft 11 is coupled to the coupling 51 so as to move in the axial direction and transmit rotation force.

In the embodiment, an axially movable amount of the drive shaft 11 is regulated within a space S1 between an axial end surface of a collar 53 fitted to an inner circumferential surface of the tube portion 51b of the coupling 51 and an end surface of the extended diameter portion 52 of the drive shaft 11. The space S1 is about 1 to several millimeters.

Further, the outer spline teeth 52a and the inner spline teeth 51a are spline-fitted while having a play in the radial direction to such an extent that an axis line O2 of the drive shaft 11 is permitted to fall slightly with respect to the axis line O1 of the crankshaft 10.

A left end of the drive shaft 11 is rotatably supported on an inner circumferential surface of the aluminum or aluminum-alloy bearing boss portion 41 via a bearing 55. In accordance with the fact that the right end of the drive shaft 11 is spline-fitted to the coupling 51 so as to move in the axial direction by the predetermined amount S1 as described above, a right end surface of the bearing 55 and a step surface 11b formed in the left end of the drive shaft 11 face each other in the axial direction across a space S2 substantially corresponding to the space S1.

An annular elastic packing 56 is fitted to an inner circumferential edge of the through hole 40 of the transmission cover 21, and an outer circumferential surface of the bearing boss portion 41 is fitted to an inner circumferential surface of the packing 56. An oil hole 57 opening in an end surface exposed to the outer side of the transmission cover 21 is formed in the bearing boss portion 41, and the oil hole 57 passes through the bearing boss portion 41 and opens in the vicinity of the bearing 55. That is, grease can be charged into the bearing 55 from the exterior via the oil hole 57.

The bearing boss portion 41 integrally has a plurality of support legs 41a. The support legs 41a are extended rightward in a curved shape along an inner circumferential surface of the dome shape front portion 21a of the transmission cover 21, and fixed to the transmission case main body 20 by bolts 58.

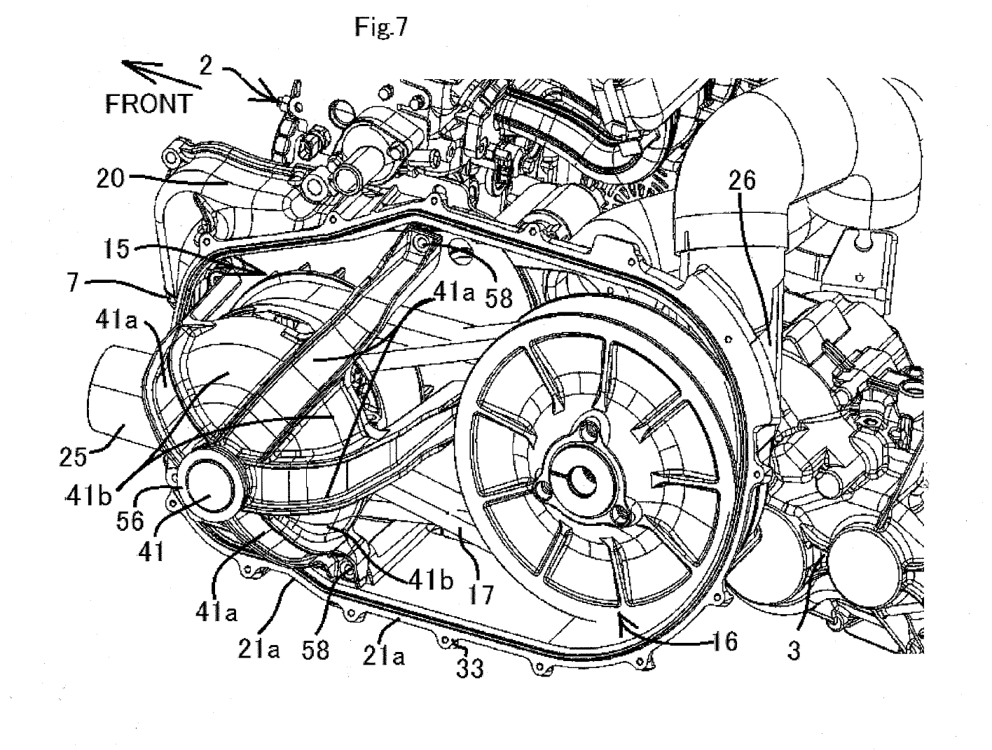

FIG. 7 is a perspective view in which the V-belt type continuously variable transmission 7 in a state that the transmission cover 21 is detached is seen from the left upper side. In the embodiment, the bearing boss portion 41 integrally has the four support legs 41a. The four support legs 41a are arranged at four points of the drive pulley assembly 15 including a front upper part, a rear upper part, a rear part, and a rear lower part, and any of the support legs 41a is formed to have a U shape section. Further, curved parts of the support legs 41a are integrally coupled by partially spherical ceiling walls 41b.

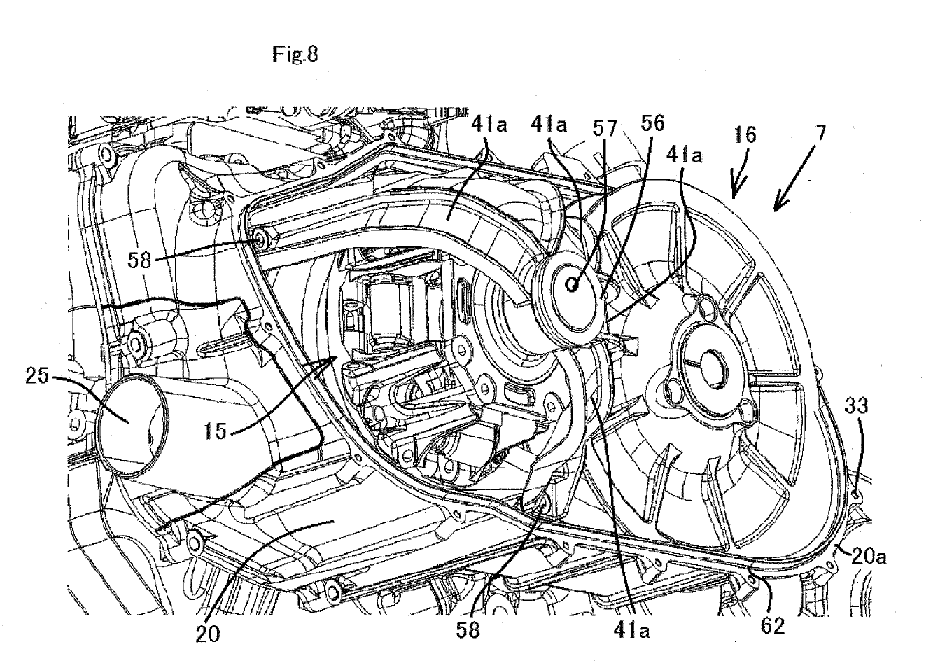

FIG. 8 is a perspective view in which the V-belt type continuously variable transmission 7 in a state that the transmission cover 21 is detached is seen from the left-front lower side. In a region of a front lower part of the drive shaft 11, the support legs 41a and the ceiling walls 41b are not formed over a range of substantially 180° about the drive shaft 11.

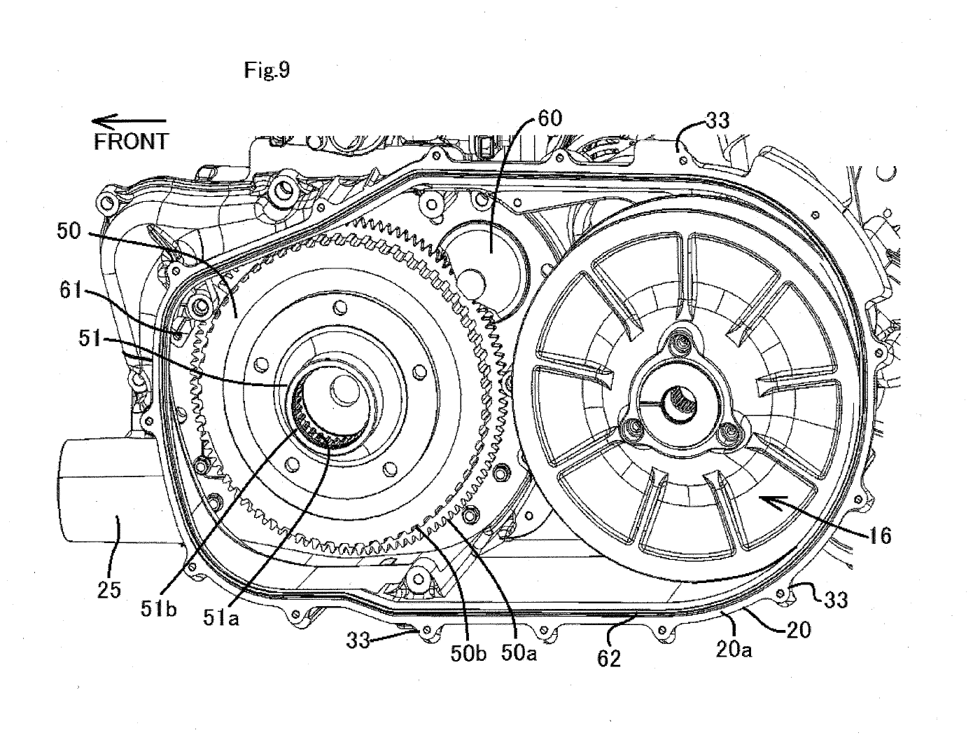

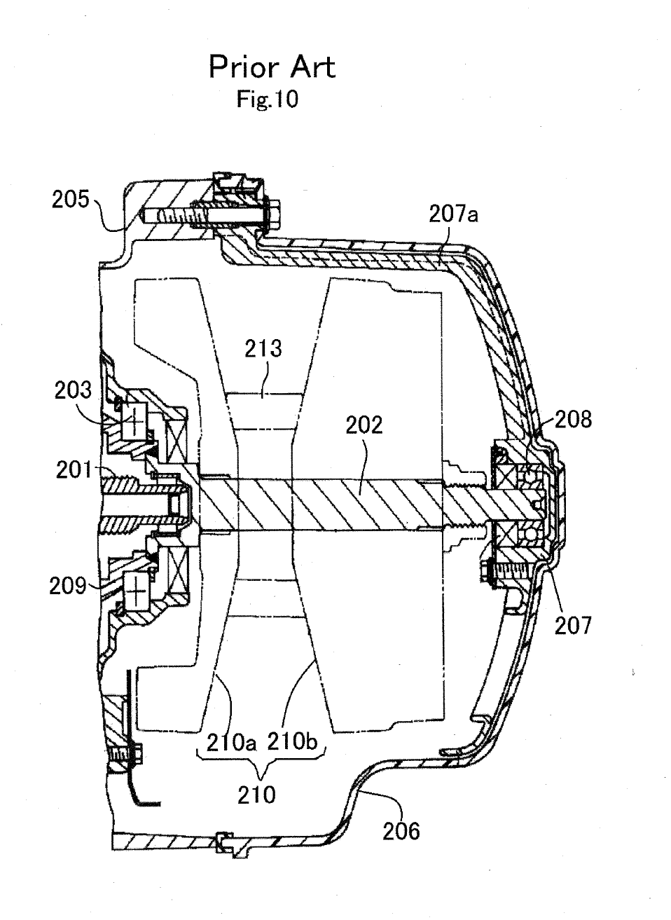

FIG. 9 is a perspective view in which the V-belt type continuously variable transmission 7 in a state that the transmission cover 21 and the drive pulley assembly 15 are detached is seen from the left upper side, clearly showing structures of the flywheel 50 and the coupling 51. On an outer circumferential surface of the flywheel 50, a starter gear 50a to be meshed with a pinion gear of a starter motor 60, and a concave and convex portion 50b for sensor reading facing a rotation sensor 61 are formed. On the cover attachment surface 20a of the transmission case main body 20, a projection 62 is formed for fitting a trim seal.

Regarding a pitch between the plurality of female screw portions 33 formed in an outer circumferential end of the transmission case main body 20, a pitch between the female screw portions 33 arranged in a front end and an upper end of a circumference of the flywheel 50 is formed to be wider than a pitch between other female screw portions 33.

### Effects According to Embodiment

(a) In FIG. 6, the transmission drive shaft 11 is formed as a separate body from the crankshaft 10, supported on both sides, and spline-fitted to the coupling 51 coupled to the crankshaft 10 so as to be permitted to fall slightly and move in the axial direction.

According to the above configuration, even in a case where an error between an axis of the bearing boss portion 41 and the axis O1 of the journal bearing portion in the engine 2 is increased due to accumulation of a manufacturing error, in comparison to a structure that a drive shaft is rigidly combined with a crankshaft, warp (bending) of the crankshaft 10 and warp (bending) of the drive shaft 11 during engine operation can be suppressed. At the time of assembling the drive shaft 11, the drive shaft 11 can be easily installed to the bearing boss portion 41 and the coupling 51.

(c) With the resin transmission cover 21, weight of the entire V-belt type continuously variable transmission 7 can be reduced. Meanwhile, by forming the metal bearing boss portion 41 as a separate body from the transmission cover 21, support rigidity of the drive shaft 11 can be maintained high.

(d) The transmission cover 21 has the through hole 40 in which the bearing boss portion 41 is fitted and supported, and the axial end surface of the bearing boss portion 41 is exposed to the exterior of the transmission cover 21. Thus, by fitting the bearing boss portion 41 in the through hole 40 at the time of attaching the transmission cover 21, the transmission cover 21 can be readily positioned and temporarily supported.

(c) The bearing boss portion 41 has the oil charging hole 57 providing communication between the exterior of the transmission cover 21 and a point of the bearing 55 in the bearing boss portion 41. Thus, oil such as grease can be charged from the exterior without detaching the transmission cover 21.

(d) The bearing boss portion 41 integrally has the plurality of support legs 41a curved along the inner circumferential surface of the dome shape front portion 21a of the transmission cover 21, and the support legs 41a are secured to the transmission case main body 20. Thus, support rigidity of the support legs 41a can be maintained high, and the axis O1 of the journal bearing portion of the engine 2 and the axis of the bearing boss portion 41 are easily matched with each other.

(e) The V-belt type continuously variable transmission 7 has a belt clutch function, and every time when the belt clutch is changed between an engage state (ON) and a disengage state (OFF), tensile force is shockingly applied to the drive pulley assembly 15. However, even in a case where such shock is repeatedly generated, with the drive shaft 11 being supported on both sides, unreasonable warp or the like of the drive shaft 11 can be prevented.

(f) An arrangement range of the plurality of support legs 41a supporting the bearing boss portion 41 leans on the side where pull force is applied to the drive pulley assembly 15 by the V belt 17, that is, a range from the front upper part of the drive pulley assembly 15 to the rear lower part through the rear part. Thus, while preventing a weight increase of the entire V-belt type continuously variable transmission, a bending action applied to the drive shaft 11 can be efficiently suppressed.

(g) As in FIG. 3, the cover attachment surface 20a formed in the transmission case main body 20 is inclined downward and outward in the vehicle width direction (leftward) with respect to the vertical plane V2 which is orthogonal to the axis line O1 of the crankshaft 10. Thus, even when the V-belt type continuously variable transmission 7 is arranged near frame members of the vehicle body frame 1, the bolts 37 can be removed and inserted from the obliquely upper side of the side of the vehicle. That is, while the engine 2 provided with the V-belt type continuously variable transmission 7 is compactly arranged in the vehicle body frame 1, attachment and detachment tasks of the transmission cover 21 are easily performed. Particularly, in the present embodiment, even when a lower end of the transmission cover 21 is arranged near a lower frame member of the vehicle body frame 1, the bolts 37 and the transmission cover 21 can be easily attached and detached from the side of the vehicle.

### Other Embodiments

(1) In the above embodiment, the transmission cover 21 is formed of a resin material. However, as described above, the transmission cover 21 can also be formed of metal such as aluminum or an aluminum alloy material as well as the transmission case main body 20.

(2) The number and layout of the support legs 41a of the bearing boss portion 41 are not limited to the above embodiment. For example, a structure having two, three, or five or more support legs 41a can also be adopted, or the support legs 41a can also be arranged so as to surround the entire circumference of the drive pulley assembly 15. The bearing boss portion can also be formed only by dome shape wall members without using the support legs.

(3) The present invention is not limited to the structure of the above embodiment but includes various modified examples obtained within a range not departing from the content described in the claims.

What is claimed is:

1. A V-belt type continuously variable transmission to be coupled to a crankshaft of an engine so as to transmit motive power, comprising:
a drive shaft;
a drive pulley assembly provided in the drive shaft; a driven shaft;
a driven pulley assembly provided in the driven shaft;
a V belt looped over both the pulley assemblies; and
a transmission case assembly for accommodating the drive shaft, the driven shaft, both the pulley assemblies, and the V belt, wherein
the drive shaft is formed as a separate body from the crankshaft,
one axial end of the drive shaft is spline-fitted to a shaft coupling portion provided in an end of the crankshaft so as to transmit rotation force, freely move in the axial direction within a predetermined distance, and be permitted to fall slightly, and
an other axial end of the drive shaft is supported in the transmission case assembly or on a bearing boss portion provided in a part of the transmission case assembly via a bearing so as to move in the axial direction within the predetermined distance.

2. The V-belt type continuously variable transmission according to claim 1, wherein the transmission case assembly includes a transmission case main body attached to a crankcase of the engine, and a resin transmission cover attached to the transmission case main body, and the bearing boss portion is formed of a metal material as a separate body from the transmission case assembly.

3. The V-belt type continuously variable transmission according to claim 2, wherein the transmission cover has a through hole in which the bearing boss portion is fitted and supported, and an axial end surface of the bearing boss portion is exposed to an exterior of the transmission cover.

4. The V-belt type continuously variable transmission according to claim 3, wherein the bearing boss portion has an oil charging hole providing communication between the end surface exposed to the exterior of the transmission cover and a point where the bearing is arranged.

5. The V-belt type continuously variable transmission according to claim 3, wherein the bearing boss portion integrally has a plurality of support legs curved along an inner circumferential surface of the transmission cover, and the support legs are secured to the transmission case main body.

6. The V-belt type continuously variable transmission according to claim 5, wherein the plurality of support legs is arranged on the side of the driven shaft with respect to an axis of the drive pulley shaft.

7. The V-belt type continuously variable transmission according to claim 1, wherein the drive pulley assembly has a belt clutch function capable of canceling a nipping pressure on the V belt by a pair of sheaves.

8. The V-belt type continuously variable transmission according to claim 2, wherein a metal transmission cover is provided in place of the resin transmission cover.
